(19) United States
(12) Patent Application Publication
(10) Pub. No.: US 2007/0155389 A1
(43) Pub. Date: Jul. 5, 2007

(54) Method for controlling header compression during handoffs in a wireless system

(75) Inventor: Qinqing Zhang, Morganville, NJ (US)

Correspondence Address: WILLIAMS, MORGAN & AMERSON, 10333 RICHMOND, SUITE 1100, HOUSTON, TX, 77042, US

(73) Assignee: Lucent Technologies, Inc.

(21) Appl. No.: 11/323,307

(22) Filed: Dec. 31, 2005

(51) Int. Cl. H04Q 7/20

(52) U.S. Cl. 455/445; 455/560

(57) ABSTRACT

A method is provided for controlling a communications session with an access terminal during a handoff between first and second radio network controllers. The method comprises receiving an indication that a call is being transferred from the first radio network controller to the second radio network controller. A compression technique to be used when sending data to the access terminal from the second radio network controller is established. The compression technique may be established by either receiving information from the first radio network controller or restarting the compression from an initial state.

### BACKGROUND OF THE INVENTION

1. Field of the Invention

This invention relates generally to telecommunications, and, more particularly, to wireless communications.

2. Description of the Related Art

In the field of wireless telecommunications, such as cellular telephony, a system typically includes a plurality of base stations (e.g., Node Bs) distributed within an area to be serviced by the system. Various Access Terminals (ATs, also known as User Equipment (UE), mobile devices, and the like) within the area may then access the system and, thus, other interconnected telecommunications systems, via one or more of the base stations. Typically, an AT maintains communications with the system as it passes through an area by communicating with one and then another base station, as the AT moves. The AT may communicate with the closest base station, the base station with the strongest signal, the base station with a capacity sufficient to accept communications, etc. The base stations, in turn, communicate with a Radio Network Controller (RNC), which communicates with a Packet Data Serving Node (PDSN). Each RNC and PDSN is capable of supporting a plurality of base stations. Thus, as an AT moves and communicates with different base stations, it may also communicate with different RNCs and PDSNs.

Internet Protocol (IP) has become the dominant transport protocol in both wireline and wireless networks. Accordingly, in many applications, IP transport protocols are used to facilitate the transfer of data between the AT and the wireless telecommunications system. In addition to IP transport protocol, other protocols, such as RTP (real-time protocol) and UDP (user datagram protocol), are added to the original information bits in the form of headers (different protocols have different headers) for effective transport in a packet data network. Over the end-to-end connection, comprised of multiple hops, these protocol headers are extremely important but over just one link (hop-to-hop) these headers can be compressed (and must be uncompressed at the other end of the link). It is possible to compress these headers, providing, in many cases, more than 90% savings, and thus reduce the bandwidth and use this expensive resource efficiently. IP header compression also provides other important benefits, such as reduction in packet loss and improved interactive response time. Thus, headers transmitted from the AT are compressed and sent to the wireless telecommunications network where they are decompressed at either the RNC or the PDSN. Likewise, headers transmitted to the AT are compressed at either the RNC or the PDSN and then decompressed at the AT.

The process of transitioning the AT from one base station to another is commonly referred to as handoff. Generally, there are two types of handoff that may occur, soft or hard. During a soft handoff there is a period of time during which the AT may be communicating with more than one base station. During a hard handoff, the link to the current base station is terminated before or as the AT is transferred to the new base station. That is, the AT is linked to no more than one base station at a given time.

A handoff may result in the AT communicating with a different base station that may connect to a different RNC and a different PDSN. However, while the AT is aware of that the hard handoff is occurring, it does not “know” whether the RNC and PDSN have been changed. Accordingly, the AT continues to send compressed packets and processes received packets using a compression/decompression technique that is not in use by the “new” RNC or PDSN. Since the new RNC or PDSN has not established the context associated with the compression/decompression, it may fail to properly decompress the received packets (or properly compress its transmitted packets), thereby causing a significant packet loss, which reduces the speed and efficiency of the communications session.

### SUMMARY OF THE INVENTION

The present invention is directed to addressing the effects of one or more of the problems set forth above. The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one aspect of the instant invention, a method is provided for controlling a communications session with an access terminal during a handoff between first and second radio network controllers. The method comprises receiving an indication that a call is being transferred from the first radio network controller to the second radio network controller. A compression technique to be used when sending data to the access terminal from the second radio network controller is established.

### BRIEF DESCRIPTION OF THE DRAWINGS

The invention may be understood by reference to the following description taken in conjunction with the accompanying drawings, in which like reference numerals identify like elements, and in which:

FIG. 1 is a block diagram of a communications system, in accordance with one embodiment of the present invention;

FIG. 2 is a stylistic representation of a region in which the communications system of FIG. 1 may be employed;

FIGS. 3A and 3B depict block diagrams of one embodiment of a base station, an access terminal and a radio network controller used in the communications system of FIG. 1;

FIG. 4 is one embodiment of a flow chart representation of a method that may be used by a target radio network controller during a handoff;

FIG. 5 is another embodiment of a flow chart representation of a method that may be used by a target radio network controller during a handoff; and

FIG. 6 is one embodiment of a flow chart representation of a method of a method that may be used by an access terminal during a handoff.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions may be made to achieve the developers' specific goals, such as compliance with system-related and business-related constraints, which may vary from one implementation to another. Moreover, it will be appreciated that such a development effort might be complex and time-consuming, but would nevertheless be a routine undertaking for those of ordinary skill in the art having the benefit of this disclosure.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

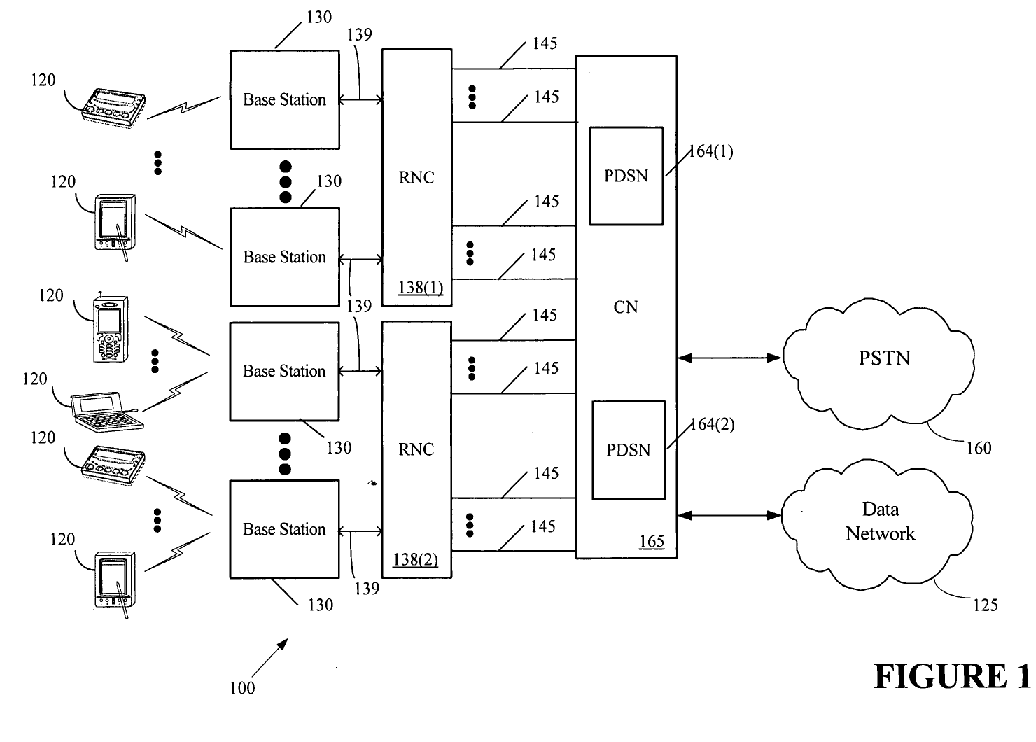

Turning now to the drawings, and specifically referring to FIG. 1, a communications system 100 is illustrated, in accordance with one embodiment of the present invention. For illustrative purposes, the communications system 100 of FIG. 1 is a Universal Mobile Telephone System (UMTS), although it should be understood that the present invention may be applicable to other systems that support data and/or voice communication. The communications system 100 allows one or more ATs 120 to communicate with a data network 125, such as the Internet, through one or more base stations 130. The AT 120 may take the form of any of a variety of devices, including cellular phones, personal digital assistants (PDAs), laptop computers, digital pagers, wireless cards, and any other device capable of accessing the data network 125 through the base station 130.

In one embodiment, a plurality of the base stations 130 may be coupled to a Radio Network Controller (RNC) 138(1-2) by one or more connections 139, such as T1/EI lines or circuits, ATM circuits, cables, optical digital subscriber lines (DSLs), and the like. Although two RNCs 138(1-2) are illustrated, those skilled in the art will appreciate that more RNCs 138 may be utilized to interface with a large number of base stations 130. Generally, the RNC 138 provides signaling and traffic processing for each wireless data session. The AT 120, BTS 130, RNC 138 and the interfaces between these components comprises a radio access network (RAN). Packet data service nodes (PDSNs) 164 reside in a core network 165 and are allocated by the service network where an AT 120 initiates a service session. The AT 120 establishes an active connection for a data session with the networks. Packets are transmitted and received from the AT 120 to the BTS 130, RNC 138, PDSN 164 and the core network 165. During mobility when the AT 120 moves from one cell to another cell, the AT 120 may need to switch to a different RNC 138 and/or PDSN 164. The RNC 138 and/or the PDSN 164 is responsible for decompressing the data signals delivered from the AT 120 through its associated base station 130 and for compressing data that is to be sent to the AT 120 through its associated base station 130.

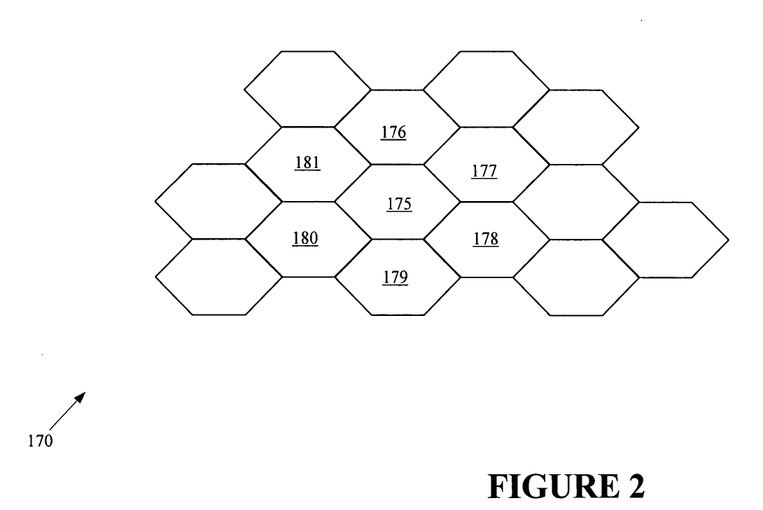

In the event that the AT 120 being serviced by the original RNC 138(1) travels into a cell being serviced by a target RNC 138(2), then the RNC 138(2) needs to “know” how to compress/decompress headers being sent to/from the AT 120. For example, as is illustrated in FIG. 2, a region 170 to be serviced by the system 100 is separated into a plurality of regions or cells, each being associated with a separate base station 130. Typically, each cell has a plurality of adjacent neighboring cells. For example, the cell 175 has six neighboring cells 176-181 such that an AT 120 entering the cell 175 may travel from one of the neighboring cells 176-181. Thus, a handoff may take place when an AT 120 enters the cell 175 from any of the neighboring cells 176-181. The cells 175-181, however, are not all necessarily served by a common RNC 138. Rather, the cell 175 may be serviced by the RNC 138(1), whereas the cell 176 may be serviced by the RNC 138(2). Thus, the handoff that occurs when the AT 120 moves from the cell 175 to the cell 176 will involve a handoff that includes the associated base stations 130, as well as the associated RNCs 138(1-2) (and the PDSNs 164(1-2)). As discussed in greater detail below, the target RNC 138(2) associated with the cell 176 may benefit from “knowing” certain characteristics associated with communications between the AT 120 and the original RNC 138(1). The target RNC 138(2) associated with the cell 176 may use this information associated with its neighboring cell 175 to smoothly transition the handoff from the original RNC 138(1).

The RNC 138 is coupled to a Core Network (CN) 165 via a connection 145, which may take on any of a variety of forms, such as T1/EI lines or circuits, ATM circuits, cables, optical digital subscriber lines (DSLs), and the like. Generally the CN 165 operates as an interface to a data network 125 and/or to a public telephone system (PSTN) 160. The CN 165 performs a variety of functions and operations, such as user authentication, however, a detailed description of the structure and operation of the CN 165 is not necessary to an understanding and appreciation of the instant invention. Accordingly, to avoid unnecessarily obfuscating the instant invention, further details of the CN 165 are not presented herein.

The data network 125 may be a packet-switched data network, such as a data network according to the Internet Protocol (IP). One version of IP is described in Request for Comments (RFC) 791, entitled “Internet Protocol,” dated September 1981. Other versions of IP, such as IPv6, or other connectionless, packet-switched standards may also be utilized in further embodiments. A version of IPv6 is described in RFC 2460, entitled “Internet Protocol, Version 6 (IPv6) Specification,” dated December 1998. The data network 125 may also include other types of packet-based data networks in further embodiments. Examples of such other packet-based data networks include Asynchronous Transfer Mode (ATM), Frame Relay networks, and the like.

As utilized herein, a “data network” may refer to one or more communication networks, channels, links, or paths, and systems or devices (such as routers) used to route data over such networks, channels, links, or paths.

Thus, those skilled in the art will appreciate that the communications system 100 facilitates communications between the ATs 120 and the data network 125. It should be understood, however, that the configuration of the communications system 100 of FIG. 1 is exemplary in nature, and that fewer or additional components may be employed in other embodiments of the communications system 100 without departing from the spirit and scope of the instant invention.

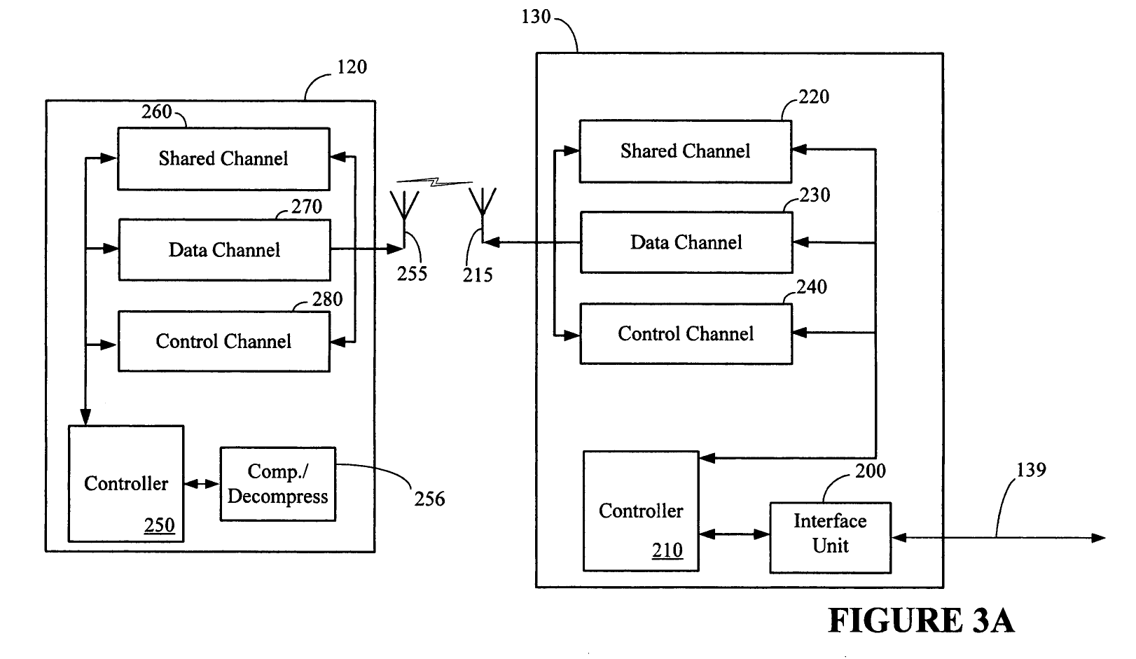

Referring now to FIG. 3A, a block diagram of one embodiment of a functional structure associated with an exemplary base station 130 and AT 120 is shown. The base station 130 includes an interface unit 200, a controller 210, an antenna 215 and a plurality of channels: a shared channel 220, a data channel 230, and a control channel 240. The interface unit 200, in the illustrated embodiment, controls the flow of information between the base station 130 and the RNC 138 (see FIG. 1). The controller 210 generally operates to control both the transmission and reception of data and control signals over the antenna 215 and the plurality of channels 220, 230, 240 and to communicate at least portions of the received information to the RNC 138 via the interface unit 200. For example, one piece of information transmitted from the base station 130 to the RNC 138 is information used by the base station 130 to communicate with the ATs 120.

The AT 120 shares certain functional attributes with the base station 130. For example, the AT 120 includes a controller 250, an antenna 255, a compressor/decompressor 256 and a plurality of channels: a shared channel 260, a data channel 270, and a control channel 280. The controller 250 generally operates to control both the transmission and reception of data and control signals over the antenna 255 and the plurality of channels 260, 270, 280. The compressor/decompressor 256 may take the form of hardware, software, or a combination thereof and may be a portion of the controller 250 or may be separately formed therefrom. Generally, the compressor/decompressor 256 is responsible for compressing headers of the packets to be sent to the RNC 138 via the base station 130 and decompressing headers of the packets received from the RNC 138 via the base station 130.

Normally, the channels 260, 270, 280 in the AT 120 communicate with the corresponding channels 220, 230, 240 in the base station 130. Under the operation of the controllers 210, 250, the channels 220, 260; 230, 270; 240, 280 are used to effect a controlled scheduling for communications from the AT 120 to the base station 130.

Referring now to FIG. 3B, a block diagram of one embodiment of a functional structure associated with an exemplary RNC 138 is shown. The RNC 138 includes, among other things, an interface unit 300, a compressor/decompressor 305 and a controller 310. The interface unit 300, in the illustrated embodiment, controls the flow of information between the base station 130 and the RNC 138 (see FIG. 1). The controller 310 is instrumental in delivering information regarding the compression/decompression of data to the target RNC 138 during a handoff. This information may be communicated to the target RNC 138 via a communication line 320 that directly or indirectly interfaces with the target RNC 138. The compressor/decompressor 305 may take the form of hardware, software, or a combination thereof and may be a portion of the controller 310 or may be separately formed therefrom. Generally, the compressor/decompressor 305 is responsible for compressing headers of the packets to be sent to the AT 120 via the base station 130 and decompressing headers of the packets received from AT 120 via the base station 130.

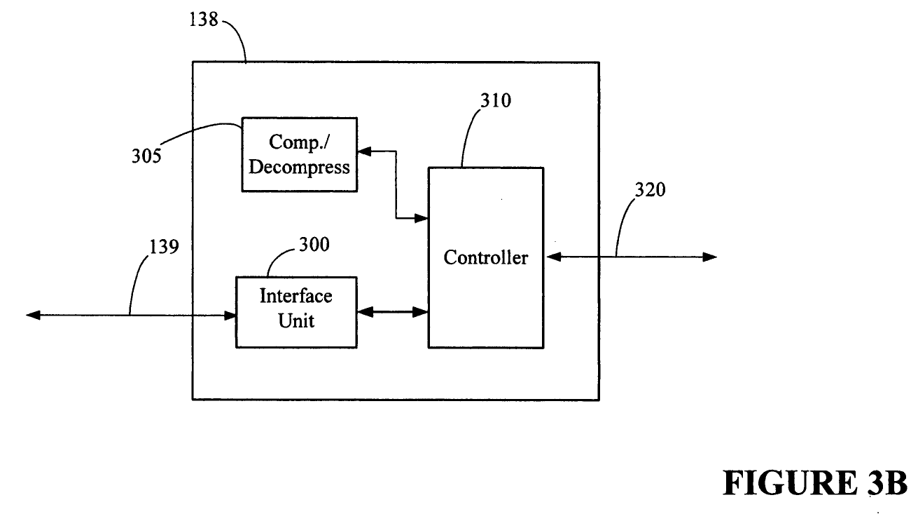

The operation of the handoff procedure is described herein in conjunction with the flowchart of FIG. 4. Generally, on the forward link or downlink direction, when a handoff involving two different RNCs 138(1-2) occurs, the call will be transferred from the original RNC 138(1) to the target RNC 138(2). FIG. 4 stylistically illustrates a flowchart representation of a first embodiment of a method of IP header compression for handoff calls that is executed in the target RNC 138(2). In the illustrated embodiment, the compression/decompression occurs at the RNC 138. However, those skilled in the art will appreciate that the methods described herein may be readily applied to the case in which the compression/decompression is located at the PDSN 164 as well.

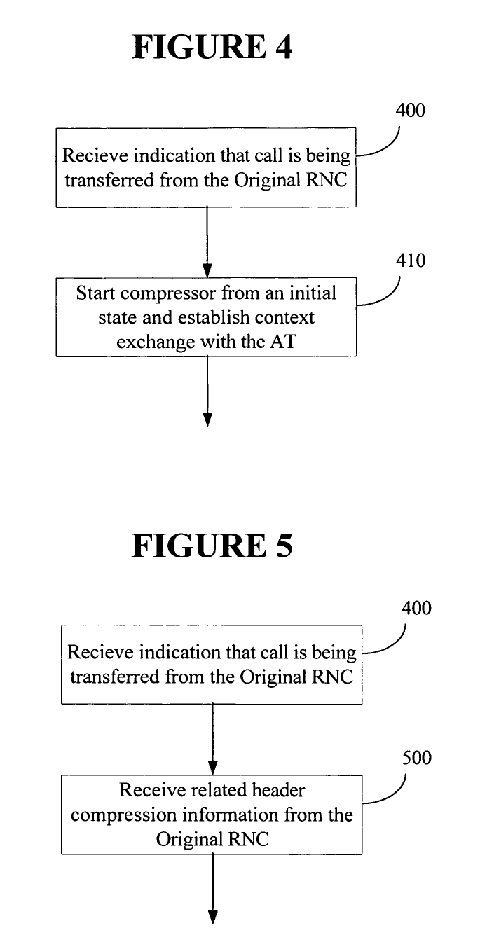

On the forward link or downlink direction, when the handoff involves two different RNC 138(1-2), the call will be transferred from the original RNC 138(1) to the target RNC 138(2). The process begins at block 400 with the target RNC 138(2) receiving an indication that the call is being transferred. To ensure that the compression/decompression will continue properly with the target RNC 138(2), the compression/decompression process is restarted from a known state, such as the initial state. In particular, at block 410, the target RNC 138(2) starts the compressor from an initial state and establishes context exchange with the AT 120. Basically the target RNC 138(2) restarts the compression procedure with the AT 120 on the forward link. Alternatively, as shown in block 500 of FIG. 5, the original RNC 138(1) passes the related header compression information, such as the context information, and compressor state, etc, to the target RNC so that the target RNC can continue the header compression and send the packets with the compressed header. Comparing the two approaches, the first approach is simple to operate and does not require extra changes or implementation for handoff calls. The advantage of the second approach is that it saves more bandwidth without the need to send the full headers during the initial compression establishment. However the second method requires the original RNC 138(1) to pass the necessary information to the target RNC 138(2) for the compression establishment, which results in additional implementation complexity.

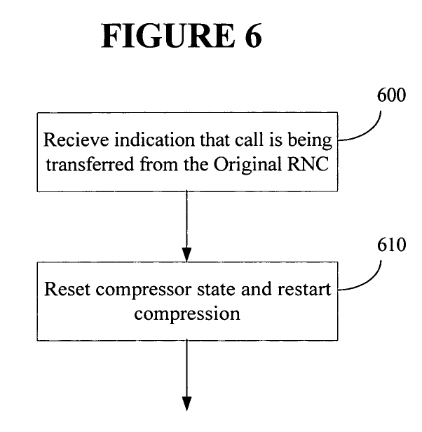

The operation of the AT 120 is shown in the functional flowchart of FIG. 6. On the reverse link or uplink direction, the AT 120 triggers and is notified of the handoff at block 600. The AT 120 responds to the handoff by resetting the compressor state and restarting the compression at block 610. There are two alternatives here as well. If the target RNC 138(2) obtains all the compressor/decompressor state and context information (e.g., as shown in FIG. 5), then the AT 120 does not need to restart the compression procedure. This approach simplifies the operation of the AT 120 but requires the specific RNC implementation. In an alternative embodiment, the AT 120 is permitted to reset and re-establish the compression procedure to ensure the quality of the connected call. It should be noted that AT 120 is aware of the handoff event since the active set (BTS 130 communicating with the AT 120) changes, but the AT 120 may not know whether a different RNC 138 will be involved in the handoff. To avoid any ambiguity, the AT 120 always restarts the compression procedure when handoff happens.

Performance may be improved in an alternative approach in which the access network notifies the AT 120 about the RNC changes via signaling messages. Then, the AT 120 will only restart the compression procedure when the RNC 138 changes.

Those skilled in the art will appreciate that the various system layers, routines, or modules illustrated in the various embodiments herein may be executable control units. The controllers may include a microprocessor, a microcontroller, a digital signal processor, a processor card (including one or more microprocessors or controllers), or other control or computing devices. The storage devices referred to in this discussion may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices. The instructions when executed by the controllers 210, 250, 310 cause the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. Consequently, the method, system and portions thereof and of the described method and system may be implemented in different locations, such as the wireless unit, the base station, a base station controller and/or mobile switching center. Moreover, processing circuitry required to implement and use the described system may be implemented in application specific integrated circuits, software-driven processing circuitry, firmware, programmable logic devices, hardware, discrete components or arrangements of the above components as would be understood by one of ordinary skill in the art with the benefit of this disclosure. It is therefore evident that the particular embodiments disclosed above may be altered or modified and all such variations are considered within the scope and spirit of the invention. Accordingly, the protection sought herein is as set forth in the claims below.

We claim:

1. A method for controlling a communications session with an access terminal during a handoff between first and second radio network controllers, comprising:
receiving an indication that a call is being transferred from the first radio network controller to the second radio network controller; and
establishing a compression technique to be used when sending data to the access terminal from the second radio network controller.

2. A method, as set forth in claim 1, wherein establishing the compression technique to be used when sending data to the access terminal from the second radio network controller further comprises starting the compression from an initial state.

3. A method, as set forth in claim 1, wherein establishing the compression technique to be used when sending data to the access terminal from the second radio network controller further comprises establishing context exchange with the access terminal.

4. A method, as set forth in claim 1, wherein establishing the compression technique to be used when sending data to the access terminal from the second radio network controller further comprises receiving information related to the compression technique from the first radio network controller.

5. A method, as set forth in claim 4, wherein receiving information related to the compression technique from the first radio network controller further comprises receiving header compression information from the first radio network controller.

6. A method, as set forth in claim 5, wherein receiving header compression information from the first radio network controller further comprises receiving context information.

7. A method, as set forth in claim 5, wherein receiving header compression information from the first radio network controller further comprises receiving compressor state information.

8. A method for controlling a communications session with an access terminal during a handoff between first and second radio network controllers, comprising:
receiving an indication at the access terminal that the communications session is being transferred from the first radio network controller to the second radio network controller; and
establishing a compression technique to be used when sending data to the second radio network controller from the access terminal.

9. A method, as set forth in claim 8, wherein establishing the compression technique to be used when sending data to the second radio network controller from the access terminal further comprises resetting a compressor state in the access terminal and restarting compression.

10. A method, as set forth in claim 8, wherein establishing the compression technique to be used when sending data to the second network controller from access terminal network controller further comprises establishing context exchange.

11. A method, as set forth in claim 8, wherein establishing the compression technique to be used when sending data to the second radio network controller from the access terminal further comprises resetting a compressor state in the access terminal and restarting compression in response to receiving a control signal from at least one of the first and second radio network controllers.
